(19) United States
(12) Patent Application Publication
(10) Pub. No.: US 2022/0186608 A1
(43) Pub. Date: Jun. 16, 2022

(54) AUTOMATED WELL PERFORMANCE EVALUATION AND PRODUCTION OPTIMIZATION

(71) Applicant: Revo Testing Technologies, Houston, TX (US)

(72) Inventors: Darryl Tompkins, Conroe, TX (US); Adam Swartley, Houston, TX (US); Oladapo Adejare, Houston, TX (US); Marci Kerls, Houston, TX (US)

(73) Assignee: Revo Testing Technologies, Houston, TX (US)

(21) Appl. No.: 17/552,265

(22) Filed: Dec. 15, 2021

Related U.S. Application Data
(60) Provisional application No. 63/125,764, filed on Dec. 15, 2020.

(51) Int. Cl. E21B 47/10; G05B 13/02

(52) U.S. Cl. CPC E21B 47/10; G05B 13/0255; G05B 13/024

(57) ABSTRACT

Aspects of the subject technology relate to systems and methods for determining well performance and optimizing production by eliminating manual rate transient analysis model matching. Systems and methods are provided for receiving well parameter data from a measurement device, determining a regression fit of rate at a first time based on the well parameter data received from the measurement device, determining a regression fit of rate at a second time based on the well parameter data received from the measurement device, comparing the regression fit of rate at the first time and the regression fit of rate at the second time, and providing instructions to a well control device based on the comparing of the regression fit of rate at the first time and the regression fit of rate the second time.

### CROSS-REFERENCE TO RELATED APPLICATIONS

This application claims benefit to U.S. Provisional Application No. 63/125,764, filed Dec. 15, 2020, which is incorporated herein by reference.

### TECHNICAL FIELD

The present technology pertains to well performance, and more particularly, to determining well performance and optimizing production by eliminating manual rate transient analysis model matching.

### BACKGROUND

Well performance can be determined by utilizing a programmable logic controller (PLC). Some systems have measurement device outputs that are directed to the PLC, which uses logic statements to determine when to adjust a well control device (e.g., “IF pressure is less than 500 PSI, THEN open a valve.” Unfortunately, this method is not applicable to most wells. Every well is different and every well flows optimally, differently.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system of well performance evaluation and production optimization in accordance with aspects of the present disclosure;

FIGS. 2A-2C illustrate an example system of automated performance diagnostics in accordance with aspects of the present disclosure;

FIG. 3 illustrates an example dashboard for a system of automated performance diagnostics in accordance with aspects of the present disclosure;

FIG. 4 illustrates example charts and a table relating to well performance interpretation in accordance with aspects of the present disclosure;

FIG. 5 illustrates an example system of increasing well performance in accordance with aspects of the present disclosure;

FIG. 6 illustrates an example chart of automated performance diagnostics including an encounter with a sand bridge in accordance with aspects of the present disclosure;

FIG. 7 illustrates another example of automated performance diagnostics in accordance with aspects of the present disclosure;

FIG. 8 illustrates yet another example of automated performance diagnostics in accordance with aspects of the present disclosure; and

FIG. 9 shows an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure considers adding a piece in between the PLC and a measurement device that can utilize methods of rate and/or pressure transient analysis to determine real time well performance and optimize production. Embodiments as described herein not only allow for programming of a PLC to open a valve at a certain pressure, but also allow for opening valves at various pressures that is optimal for a corresponding reservoir that may also be based on a real time evaluation of well performance.

In some embodiments, the system as described herein may include three primary parts that work together in a process to automatically evaluate well performance and optimize production by controlling a well flow rate. For example the system may include: 1) a well control device (e.g., choke or artificial lift); 2) a measurement device (e.g., flow meters, pressure/temperature sensors, etc.); and 3) systems described herein (e.g., Revo iQ software). The system further can eliminate operators on location who manually control the flow of the well and time consuming manual Rate Transient Analysis (“RTA”) model matching that may be needed for well evaluations and production optimization. The system may also provide automated real time well performance assessments that may be utilized to optimize production from hydrocarbon producing wells. The system is more efficient in that it saves time and money, and the system also provides a more streamlined method that optimizes real time draw down.

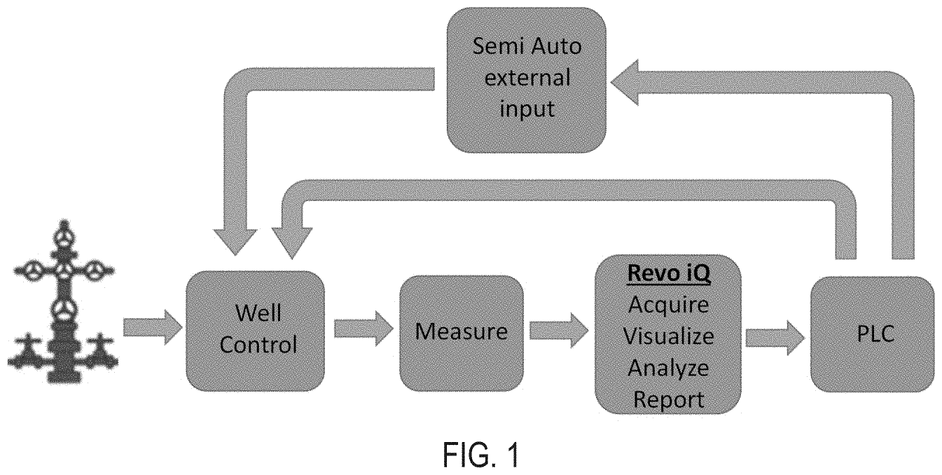

FIG. 1 illustrates an example system of well performance evaluation and production optimization in accordance with aspects of the present disclosure.

In some embodiments, the system can be utilized to automatically/semi-automatically control a device that controls the flowrate and/or pressure from a well in real time. The system can further include a well control device (e.g., choke or artificial lift) that can provide adjustments derived from an automated well performance evaluation by utilizing rate and/or pressure transient data. The system can further be operated automatically, or semi automatically. When operated automatically, the system does not require any external input. When operated semi-automatically, an external input of the system can include a user acknowledging the recommendation from the system prior to changing well control parameters.

In some embodiments, the system can utilize an algorithm that includes a regression fit of rate normalized pressure data. The regression fit can be used to calculate well performance parameters (e.g., RNP slope, y intercept, permeability, fracture half length, and contacted volume), which may then be compared to the well performance parameters of a previous transient. Ratios of a current to previous KPI's may then be computed to determine the magnitude of increase in KPI. This value may then be represented in a colored histogram and gauge for users to determine how these variables have changed throughout the entire test.

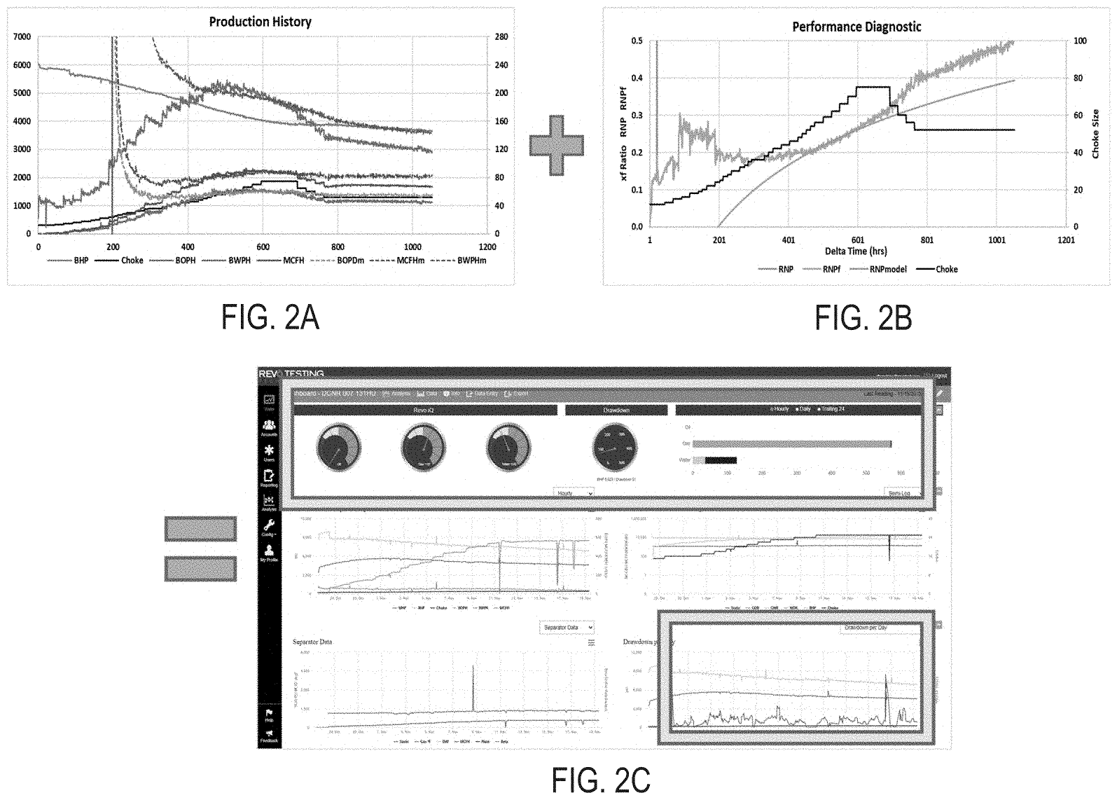

FIGS. 2A-2C illustrate an example system of automated performance diagnostics in accordance with aspects of the present disclosure.

Rate and pressure data may be acquired by the system (e.g., Revo iQ software), which may then be visualized and analyzed in a dashboard. Revo Automated Performance Diagnostic (RAPD) and APEX tools of the system (e.g., in Revo iQ) may automatically determine and fit well flow models to the production data and determine well performance parameters. From this, the system can determine and record any changes in well performances as new data. The relative change in well performance can be displayed as color indicators in the dashboard (e.g., Revo iQ) for users to see well performance for semi-automatic well control. In other embodiments, outputs from the RAPD and APEX tools of the system can be utilized to directly control well performance parameters. If well performance has increased, the system can provide a recommendation for adjusting the flow control device or the system can adjust the flow control device automatically.

FIG. 2A illustrates data that may be streamed (input in substantially real time) into the system (e.g., Revo iQ) and visualized. FIG. 2B illustrates RAPD and APEX tools of the system automatically fitting a flow model to the data from FIG. 2A. FIG. 2C illustrates outputs from RAPD and APEX of the system (e.g., Revo iQ) and inputs relating to flow control.

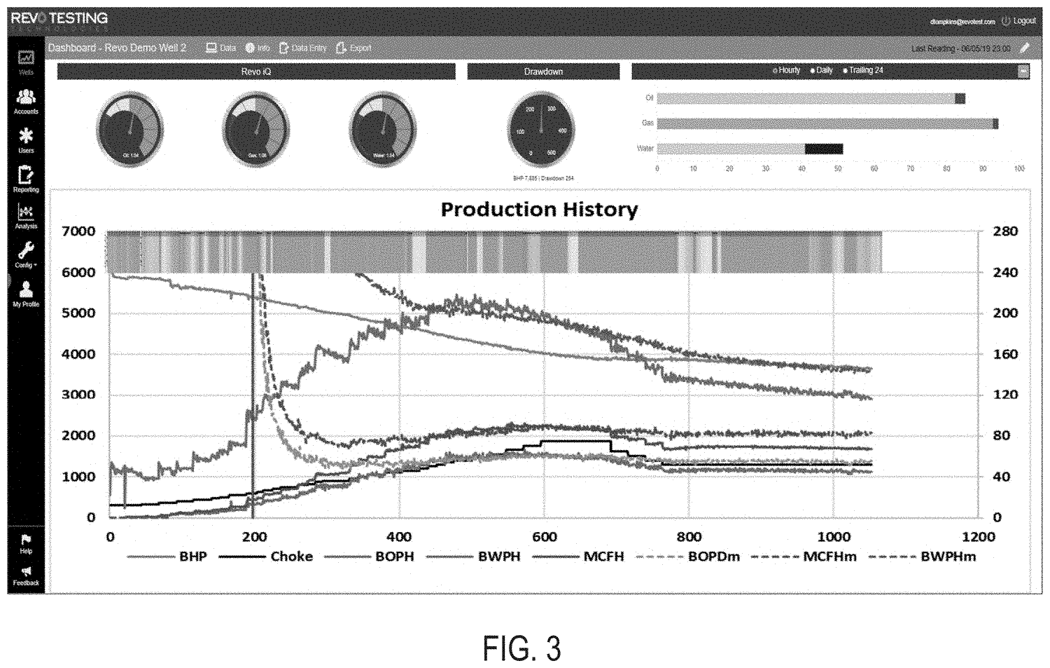

FIG. 3 illustrates an example dashboard for a system of automated performance diagnostics in accordance with aspects of the present disclosure.

In some embodiments, instantaneous outputs from RAPD of the system can be seen in KPIs located at the top of the Revo iQ dashboard. A colored histogram is shown at the top of the Production History plot to demonstrate what color would be indicated on the Revo iQ gauges.

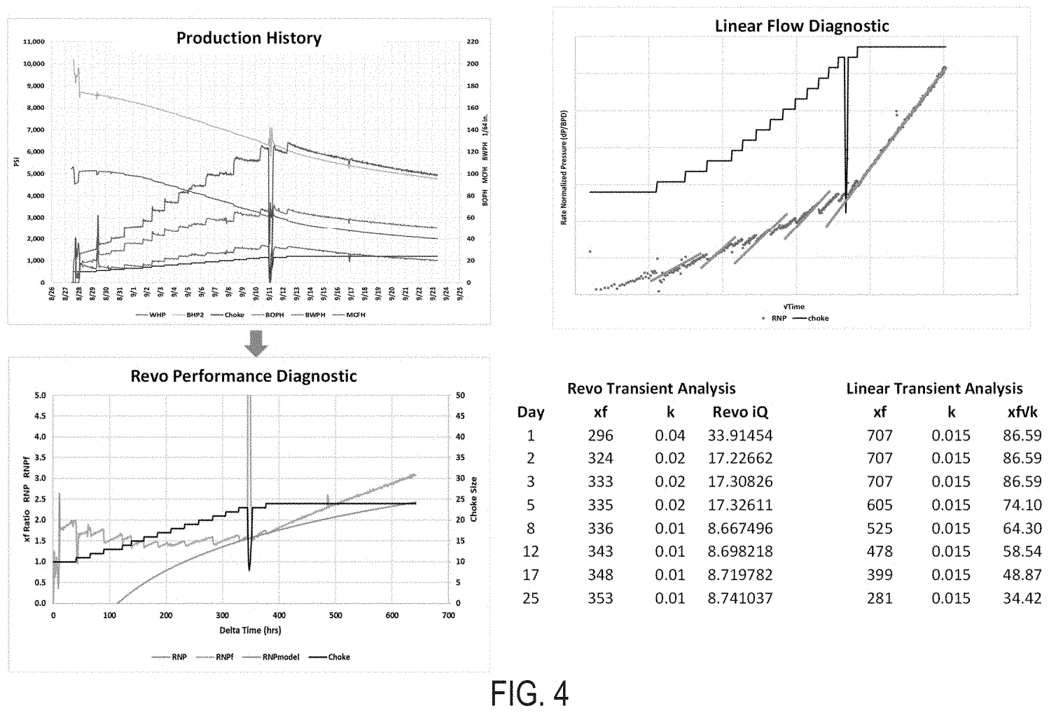

FIG. 4 illustrates example charts and a table relating to well performance interpretation in accordance with aspects of the present disclosure.

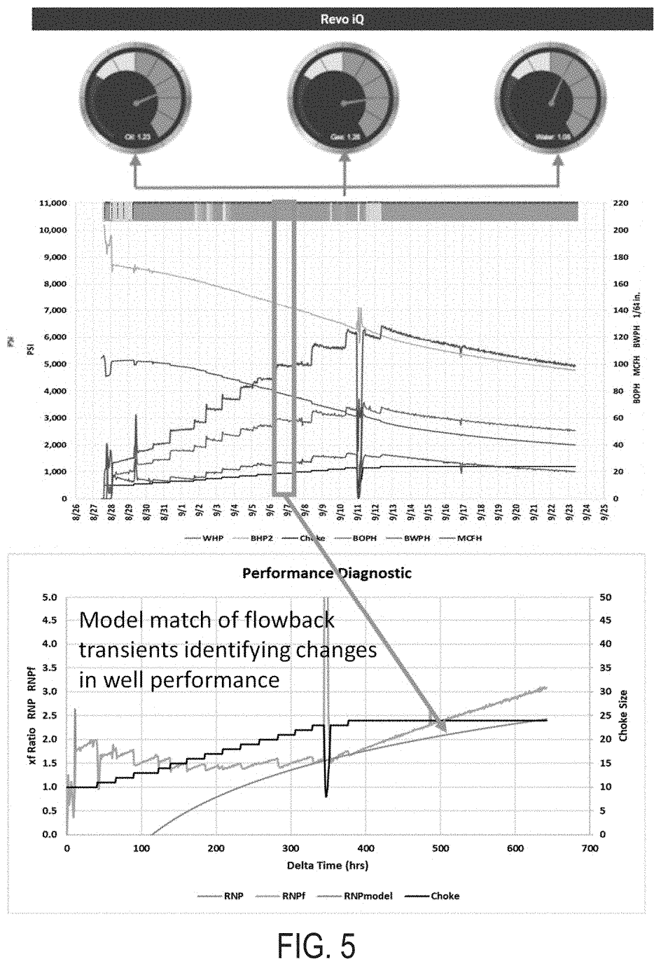

FIG. 5 illustrates an example system of increasing well performance in accordance with aspects of the present disclosure.

Traditional RTA methods are not well suited for flowback analysis.

In some embodiments of the present disclosure, the system can utilize a diagnostics analysis work flow, combined with proprietary software, to optimize well performance during flowback. The system can continuously monitor well flow data and analyze well performance to efficiently produce the well, which has been shown to increase EUR. The system can also automatically analyze well performance and provides real time feedback on choke recommendations via Revo iQ® gauges in the dashboard.

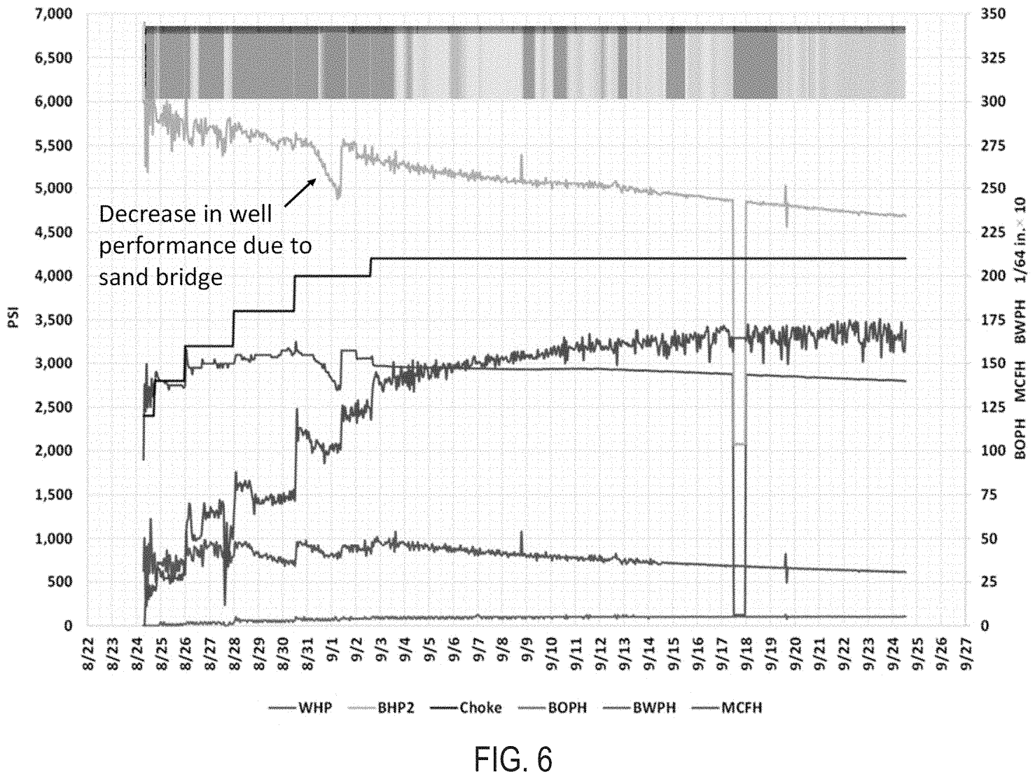

FIG. 6 illustrates an example chart of automated performance diagnostics including an encounter with a sand bridge in accordance with aspects of the present disclosure. For example, decrease in well performance due to sand bridge.

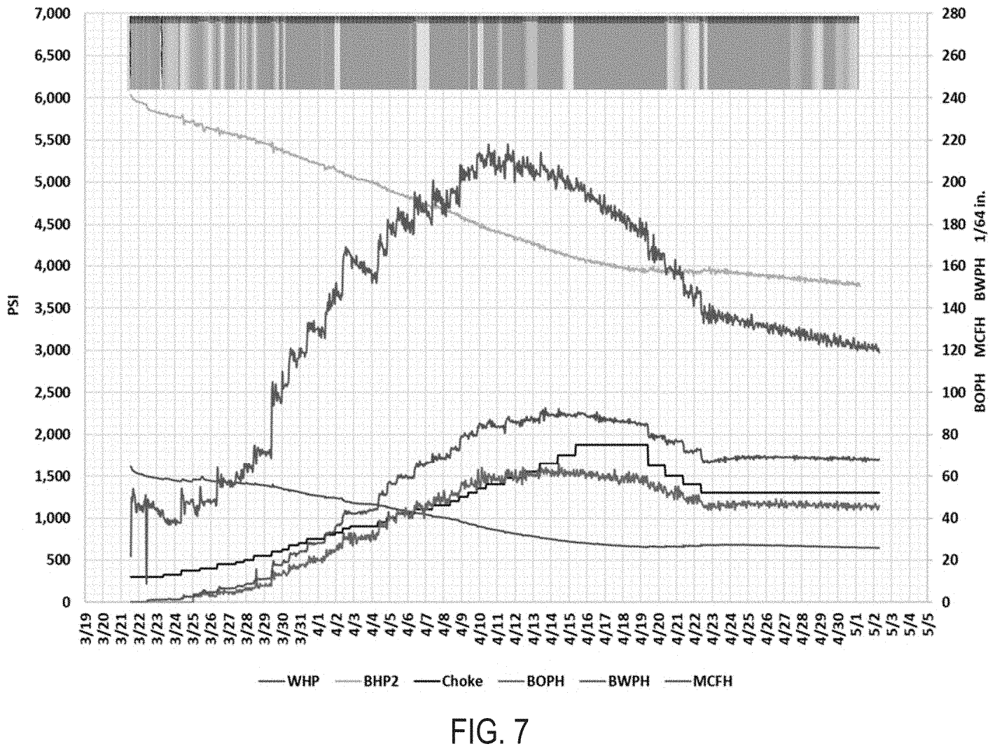

FIG. 7 illustrates another example of automated performance diagnostics in accordance with aspects of the present disclosure.

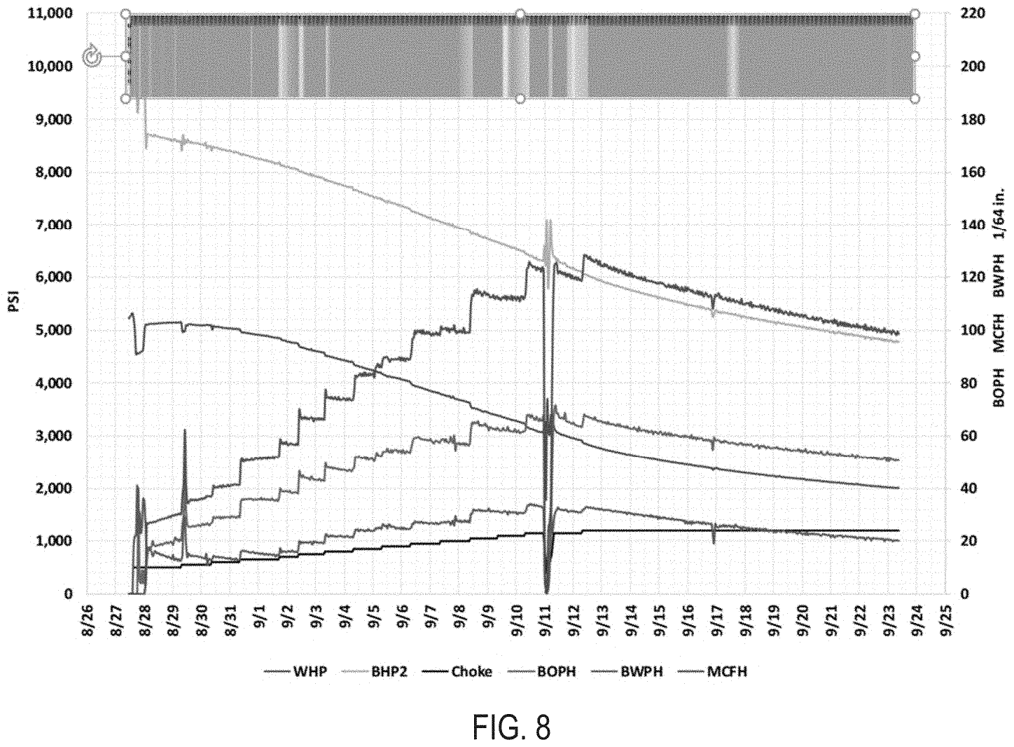

FIG. 8 illustrates yet another example of automated performance diagnostics in accordance with aspects of the present disclosure.

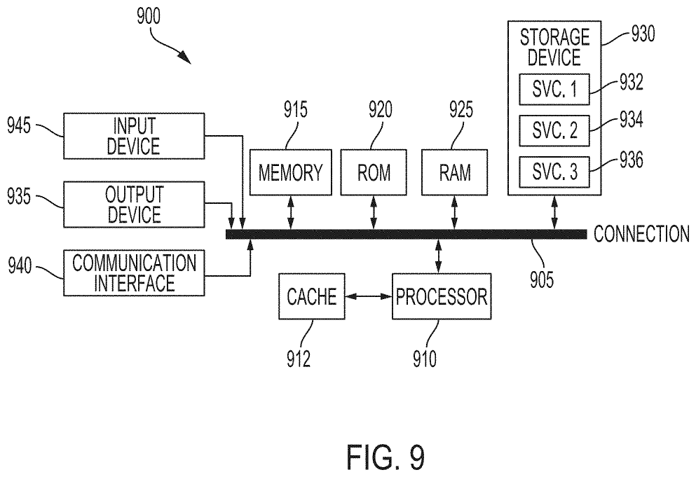

FIG. 9 illustrates an example computing device architecture 900 which can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 9 illustrates an example computing device architecture 900 of a computing device which can implement the various technologies and techniques described herein. The components of the computing device architecture 900 are shown in electrical communication with each other using a connection 905, such as a bus. The example computing device architecture 900 includes a processing unit (CPU or processor) 910 and a computing device connection 905 that couples various computing device components including the computing device memory 915, such as read only memory (ROM) 920 and random access memory (RAM) 925, to the processor 910.

The computing device architecture 900 can include a cache of high-speed memory connected directly with, in close proximity to, or integrated as part of the processor 910. The computing device architecture 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other computing device memory 915 may be available for use as well. The memory 915 can include multiple different types of memory with different performance characteristics. The processor 910 can include any general purpose processor and a hardware or software service, such as service 1932, service 2934, and service 3936 stored in storage device 930, configured to control the processor 910 as well as a special-purpose processor where software instructions are incorporated into the processor design. The processor 910 may be a self-contained system, containing multiple cores or processors, a bus, memory controller, cache, etc. A multi-core processor may be symmetric or asymmetric.

To enable user interaction with the computing device architecture 900, an input device 945 can represent any number of input mechanisms, such as a microphone for speech, a touch-sensitive screen for gesture or grail input, keyboard, mouse, motion input, speech and so forth. An output device 935 can also be one or more of a number of output mechanisms known to those of skill in the art, such as a display, projector, television, speaker device, etc. In some instances, multimodal computing devices can enable a user to provide multiple types of input to communicate with the computing device architecture 900. The communications interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. The storage device 930 can include services 932, 934, 936 for controlling the processor 910. Other hardware or software modules are contemplated. The storage device 930 can be connected to the computing device connection 905. In one aspect, a hardware module that performs a particular function can include the software component stored in a computer-readable medium in connection with the necessary hardware components, such as the processor 910, connection 905, output device 935, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, cloud-based storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

The disclosure of provisional patent application filed Dec. 15, 2021 and having application No. 63/289,987 is hereby incorporated herein by reference in its entirety.

What is claimed is:

1. A method comprising:
receiving well parameter data from a measurement device;
determining a regression fit of rate at a first time based on the well parameter data received from the measurement device;
determining a regression fit of rate at a second time based on the well parameter data received from the measurement device;
comparing the regression fit of rate at the first time and the regression fit of rate at the second time; and
providing instructions to a well control device based on the comparing of the regression fit of rate at the first time and the regression fit of rate the second time.
